(19) United States
(12) Patent Application Publication
(10) Pub. No.: US 2005/0219165 A1
(43) Pub. Date: Oct. 6, 2005

(54) Electroluminescent color-change technology

(76) Inventor: Paul Regen, Felton, CA (US)

Correspondence Address: CENTRAL COAST PATENT AGENCY, PO BOX 187, AROMAS, CA, 95004, US

(21) Appl. No.: 10/931,514

(22) Filed: Aug. 31, 2004

Related U.S. Application Data
(60) Provisional application No. 60/558,379, filed on Mar. 31, 2004.

(51) Int. Cl. G09G 3/28

(52) U.S. Cl. 345/76; 345/102

(57) ABSTRACT

A variable-color display system has at least one area of electroluminescent material, a power supply connected to the area of electroluminescent material, providing electromotive force (emf) to the material, and variable frequency control circuitry for controlling frequency of application of the emf applied to the area of electroluminescent material, wherein by varying the frequency the apparent color of the display is changed. In some embodiments pixilated displays are provided.

### CROSS-REFERENCE TO RELATED DOCUMENTS

The present invention claims priority to provisional patent application Ser. No. 60/558,379, filed on Mar. 31, 2004. The specification of provisional 60/558,379 is included herein in its entirety by reference.

### FIELD OF THE INVENTION

The present invention is in the field of color management for surfaces in a variety of applications, and pertains more particularly to color management for electroluminescent panels and devices.

### BACKGROUND OF THE INVENTION

There are many uses for lighted panels, such as for backlighting displays and keyboards, for example. The present inventors have a particular interest in backlighting keyboards for use in unlighted or dimly lighted environments. Further it is well-known that such panels may be illuminated in a variety of ways. One way is to provide a translucent panel and to place conventional light sources, such as incandescent bulbs or high-intensity LEDs behind the translucent panel. Another is to form the panel itself from an array of individual, small LEDs or LCDs and to activate the individual elements in the matrix, either in a programmed way or simultaneously.

If one uses electroluminescent elements, it is well known that different colors in electroluminescence are available through differently doped materials. A slightly blue-doped material may be used for example, to produce an attractive blue radiance when driven at a specified voltage and frequency. Most manufacturers also provide materials for specific colors to be used with typical voltage and frequency available for use in electrical and electronic products. A common driving power is about 100 V^{RMS} at about 400 Hz. Other colors may be provided with differently doped materials.

Typically in the art an electroluminescent panel will be powered by a static power supply (at a particular voltage and frequency) and the panel will exhibit a color characteristic of the doping at the power-level. Still, the inventors are aware that a panel such as a flat panel to be used for backlighting such as a keyboard for a computer, would be very useful and attractive if the color could be dynamically varied.

So what is needed is an electroluminescent panel that can be controlled dynamically to exhibit a broad range of different colors. Panels described below in embodiments of the present invention provide just such color control.

### SUMMARY OF THE INVENTION

In an embodiment of the present invention a variable-color display system is provided, having at least one area of electroluminescent material, a power supply connected to the area of electroluminescent material, providing electromotive force (emf) to the material, and variable frequency control circuitry for controlling frequency of application of the emf applied to the area of electroluminescent material. By varying the frequency the apparent color of the display is changed.

In some embodiments the power supply is a variable voltage power supply, whereby the voltage may be varied to alter the intensity of the color exhibited. Also in some embodiments there are two or more areas of electroluminescent material powered by the power supply, wherein the variable frequency control circuitry controls frequency for the two or more areas independently. In other embodiments the power supply providing emf is a variable voltage power supply, allowing voltage level to be varied.

In some embodiments there are three areas of electroluminescent material, a first area comprising material formulated to provide a red color at a predetermined voltage and frequency, a second area comprising material formulated to provide a green color at a predetermined voltage and frequency, and a third area comprising material formulated to provide a blue color at a predetermined voltage and frequency, the three areas adjacent in close proximity and electrically isolated from one another.

Also in some embodiments each of the three areas are implemented as adjacent spots forming a pixel, and further comprising a plurality of such pixels in matrix, forming a pixilated R G B display panel. In alternative each of the three areas may be implemented as a long line, the areas side-by-side and electrically insulated, and comprising a plurality of line sets forming a display. In still other embodiments each of the three areas is implemented as a long line, the areas side-by-side and electrically insulated, and the set of side-by-side long lines are formed in a spiral pattern.

In another embodiment of the invention there may be two areas of electroluminescent material, a first area comprising material formulated to provide a range of red color under frequency control, and a second area comprising material formulated to provide a range of colors including various shades of both green and blue color under frequency control, the three areas adjacent in close proximity and electrically isolated from one another. Each of the areas may be implemented as adjacent spots forming a pixel, and there may further be a plurality of such pixels in matrix, forming a pixilated R G B display panel.

In one embodiment of the two-area display element frequency control is enabled to provide one frequency to the first area for a predetermined period of time, a second frequency to the second area for a first portion of the period of time, and a third frequency to the second area for a second portion of the period of time.

In some embodiments each of the two areas is implemented as a long line, the areas side-by-side and electrically insulated, and there may further be a plurality of line sets forming a display. In some cases each of the areas may be implemented as a long line, the areas side-by-side and electrically insulated, and the set of side-by-side long lines may be formed in a spiral pattern.

In another aspect of the present invention a method for providing a variable-color display system is provided, comprising (a) forming at least one area of electroluminescent material; (b) connecting a power supply to the area of electroluminescent material, providing electromotive force (emf) to the material; and (c) providing variable frequency control to the application of the emf to the area of electroluminescent material, altering the apparent color of the panel according to the frequency.

In some embodiments of the method the power supply is a variable voltage power supply, whereby the voltage may be varied to alter the intensity of the color exhibited. Also in some embodiments there are two or more areas of electroluminescent material powered by the power supply, wherein the variable frequency control circuitry controls frequency for the two or more areas independently. In other embodiments the power supply providing emf is a variable voltage power supply, allowing voltage level to be varied.

In some embodiments there are three areas of electroluminescent material, a first area comprising material formulated to provide a red color at a predetermined voltage and frequency, a second area comprising material formulated to provide a green color at a predetermined voltage and frequency, and a third area comprising material formulated to provide a blue color at a predetermined voltage and frequency, the three areas adjacent in close proximity and electrically isolated from one another.

Also in some embodiments each of the three areas are implemented as adjacent spots forming a pixel, and further comprising a plurality of such pixels in matrix, forming a pixilated R G B display panel. In alternative each of the three areas may be implemented as a long line, the areas side-by-side and electrically insulated, and comprising a plurality of line sets forming a display. In still other embodiments each of the three areas is implemented as a long line, the areas side-by-side and electrically insulated, and the set of side-by-side long lines are formed in a spiral pattern.

In another embodiment of the invention there may be two areas of electroluminescent material, a first area comprising material formulated to provide a range of red color under frequency control, and a second area comprising material formulated to provide a range of colors including various shades of both green and blue color under frequency control, the three areas adjacent in close proximity and electrically isolated from one another. Each of the areas may be implemented as adjacent spots forming a pixel, and there may further be a plurality of such pixels in matrix, forming a pixilated R G B display panel.

In one embodiment of the two-area display element frequency control is enabled to provide one frequency to the first area for a predetermined period of time, a second frequency to the second area for a first portion of the period of time, and a third frequency to the second area for a second portion of the period of time.

In some embodiments each of the two areas is implemented as a long line, the areas side-by-side and electrically insulated, and there may further be a plurality of line sets forming a display. In some cases each of the areas may be implemented as a long line, the areas side-by-side and electrically insulated, and the set of side-by-side long lines may be formed in a spiral pattern.

In various embodiments of the invention taught in enabling detail below, for the first time an entirely new display technology is made available, which is useful for all-on-color displays, used for such as backlighting, as well as for sophisticated displays capable of video displaying.

### BRIEF DESCRIPTION OF THE DRAWING FIGURES

FIG. 1a is an illustration of an electroluminescent panel and power elements according to one embodiment of the present invention.

FIG. 1b is an illustration of an electroluminescent panel and power elements according to an alternative embodiment of the present invention.

FIG. 2a is an illustration of an electroluminescent pixel element and power elements according to another alternative embodiment of the present invention.

FIG. 2b is an illustration of an electroluminescent pixel element and power elements according to yet another alternative embodiment of the present invention.

FIG. 2c is a diagrammatical illustration of frequency control for the pixel of FIG. 2b.

FIG. 2d is a timing diagram illustrating frequency application for the pixel of FIG. 2b.

FIG. 3 is a plan view of another electroluminescent panel according to an embodiments of the present invention.

FIG. 4 is an illustration of an alternative way to form an electroluminescent panel in an embodiment of the invention.

### DESCRIPTION OF PREFERRED EMBODIMENTS

What is less well-known than the particulars discussed above in the Background section, is that one particular material, such as the slightly blue-doped material mentioned above, driven at different voltages and/or frequency, may be caused to exhibit a range of colors and intensities from green in several different shades to deep sapphire blue. This phenomenon is true of panels and substrates doped to produce any one of a broad variety of colors, any one of which may be caused by voltage and frequency control to exhibit a range of colors and intensities.

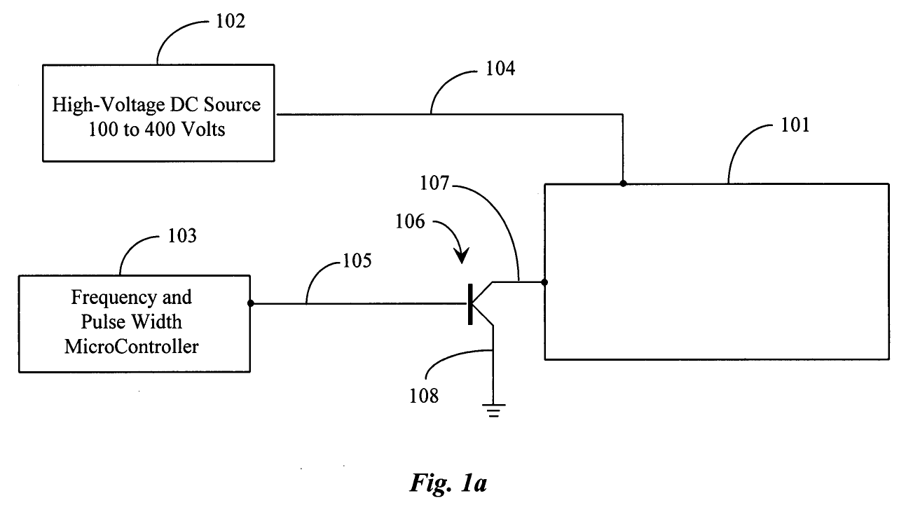

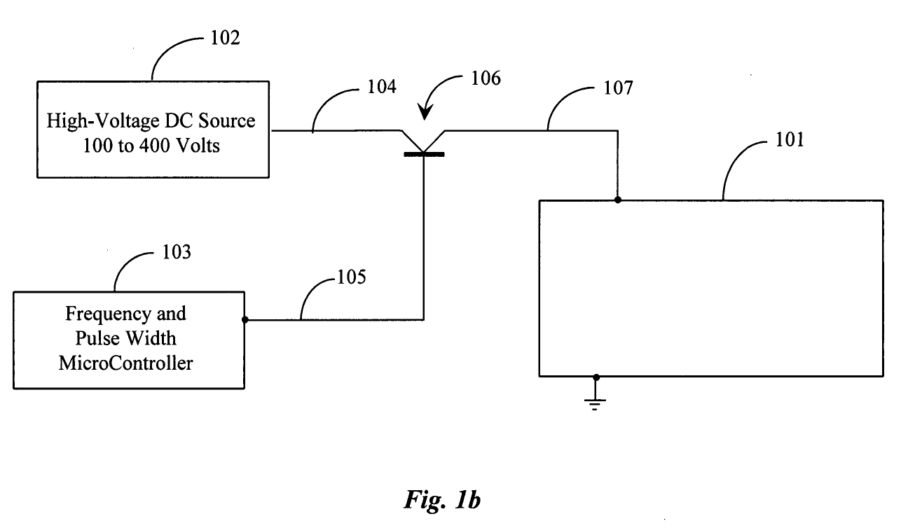

FIG. 1a is an illustration of an electroluminescent panel 101 and power elements according to one embodiment of the present invention. Panel 101 is made of an electroluminescent material doped to exhibit a particular color when powered at a specific voltage and frequency. The slightly blue-producing material described previously is exemplary. Panel 101 is connected by a line 104 to a high-voltage DC source 102 to power the panel at from about 100 to 400 volts DC. There may be an on-off switch or other control elements not shown.

Panel 101 in this embodiment is also connected to ground through a transistor 106 by lines 107 and 108. A microcontroller 103 controls the gate of transistor 106 to connect panel 101 alternately to ground through line 108. There may be control elements not shown, such as inputs to vary the frequency and pulse width, and in some cases there may be elements to automate the operation of microcontroller 103, to provide a programmable pattern of frequency and/or pulse-width variation.

In the embodiment of FIG. 1, then, panel 101 may be of relatively large extent, for example to backlight a cell phone display, a display for a PDA or a game controller, or even a keyboard. By appropriate control of voltage from supply 102 and frequency and/or pulse width by controller 103, the panel may be caused to exhibit a broad range of colors from green in several different shades to deep sapphire blue, and may also be caused to exhibit the colors at different levels of intensity.

FIG. 1b is an illustration of an electroluminescent panel and power elements according to an alternative embodiment of the present invention. In this embodiment transistor 106 is connected by line 104 to power supply 102, line 107 provides frequency-controlled power to panel 101 and controller 103 still controls the gate of transistor 106 through line 105. In some other embodiments the control of frequency and pulse width is integrated entirely into power supply 102, and appropriate control are provided, either manual or automatic, to vary both the emf and the frequency and pulse width. There are indeed a variety of ways that control of power to the panel may be implemented. It is important to the invention that at least the frequency be variable, although the voltage level and the pulse width may also be separately controllable.

The skilled artisan will be aware that there will be many uses for a panel with such variability as described above, varying backlight intensity and colors for a wide range of needs. One might, for example, provide color and intensity control knobs for backlight panels so intensity and color may be varied depending on ambient light conditions. In other cases frequency and/or voltage may be varies automatically to provide a programmed variability of colors.

It has also occurred to the present inventor that in a unique combination the phenomena described above may be used with two, three or more differently doped portions to provide a much broader range of colors than might be created with a panel comprising a single doped material.

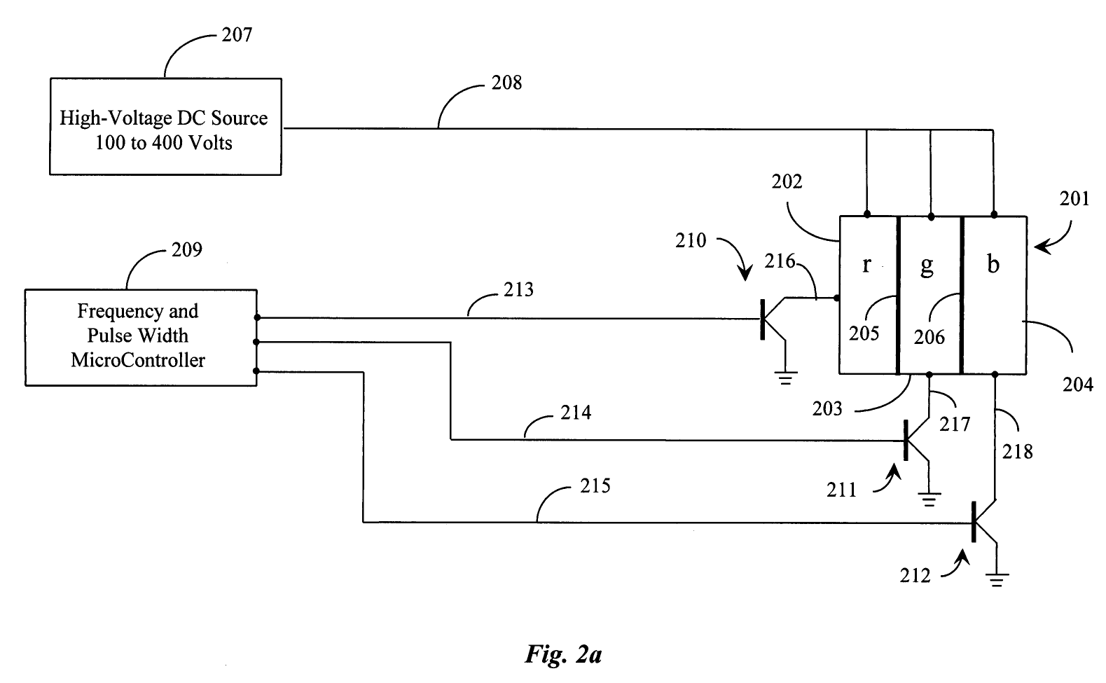

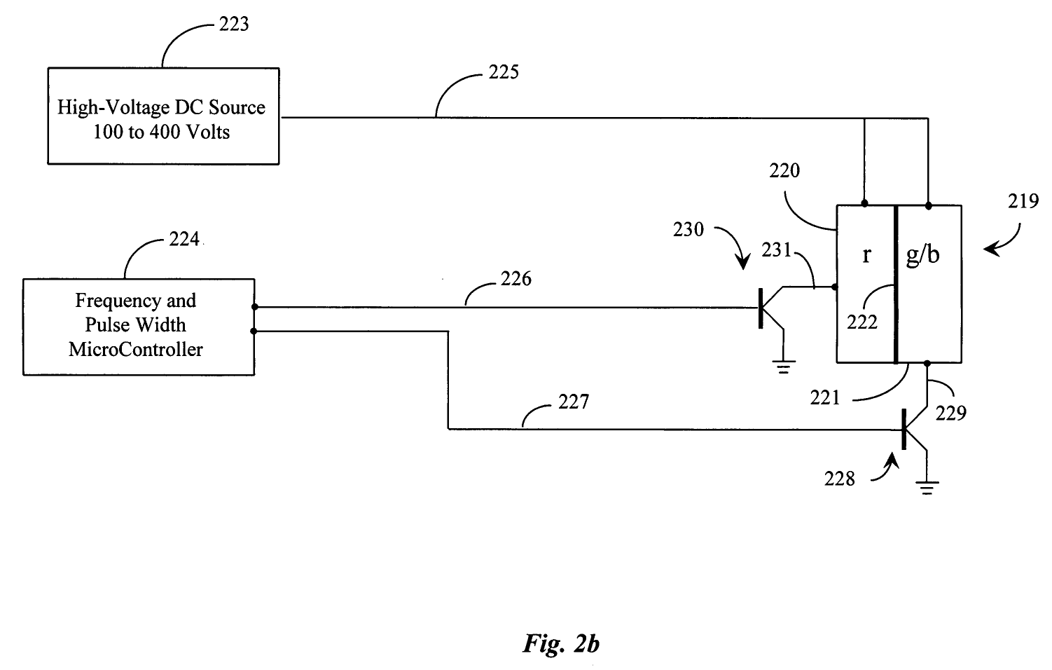

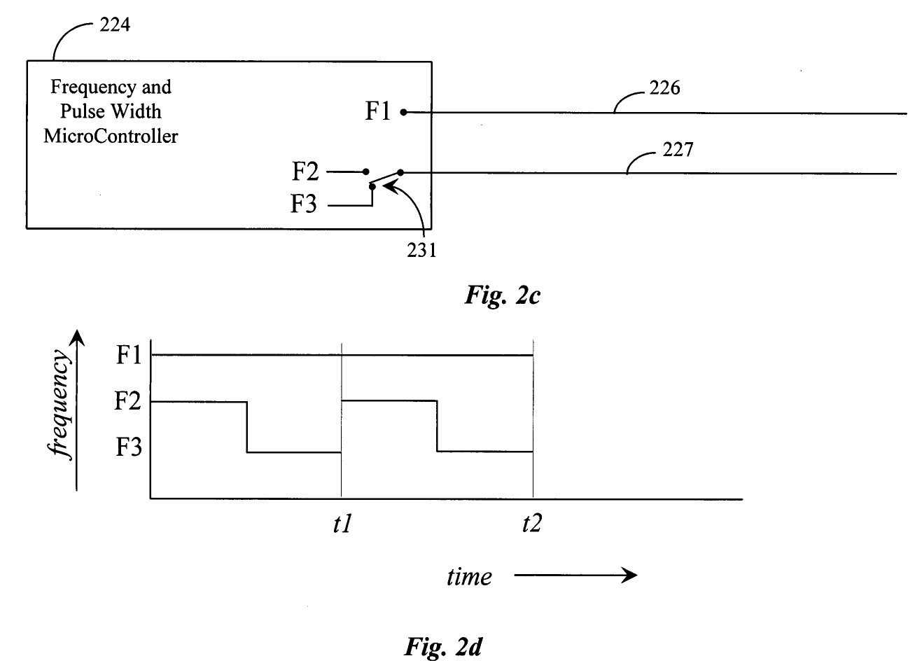

FIG. 2a is an illustration of an element 201 for an alternative panel according to an embodiment of the present invention, together with power and drive elements. Element 201 is in this embodiment a pixel-sized element comprising three different doped areas, these being areas 202, 203 and 204. By pixel-sized is meant small enough that the human eye will summarize the three different colors of areas 202, 203 and 204 and register one combination color for the viewer, as happens in the case of RGB technology in color TVs and other types of displays, where individual “spots” of red, green and blue in varying intensity are used to provide pixels of apparent color in different areas of a display. As a rough example, a screen of about ten inches in width may have as many as one-thousand or more pixels in a horizontal line. The size of each pixel is therefore less than one one-hundredth of an inch in width.

Given the above description, the skilled artisan will recognize however, that the pixel-size description is relative, because it depends as well on the distance a viewer may be from a display. For example, a very large panel used as an advertisement in a billboard-like display on a building will be viewed from a relatively long distance, and may therefore have pixels of a rather large size, which would not be discerned as integrated color if viewed from, say three feet away; but would work just fine when viewed from thirty feet away.

In this example area 202 is doped for red, area 203 for green, and area 204 for blue, following the RGB convention. Lines 205 and 206 represent electrically-insulating materials, of which there are a variety that may be used, so each of the three areas is electrically isolated from the others. High-voltage DC source 207 powers all three of areas 202, 203 and 204 in this embodiment, although in some embodiments the areas may have separate power supplies, so each area may be driven by a different voltage.

In the example of FIG. 2a each of areas 202, 203 and 204 is connected to ground through a separate transistor via lines 216, 217 and 218 respectively, these being transistors 210, 211 and 212 respectively. Gates of transistors 210, 211 and 212 are separately controlled by microcontroller 209 through lines 213, 214 and 215 such that each area may be powered at a different frequency and/or pulse width, providing for color control. Thus the intensity and relative color of each area 202, 203 and 204 may be controlled such that a truly wide range of colors may be displayed for the apparent pixel of areas 202, 203 and 204.

Recalling the description above for a single-element panel, it is also true in this case that the transistors may instead be in the lines to areas 202, 203 and 204 from power supply 207, just as transistor 106 is shown in FIG. 1b. Further all of the comments above about alternative ways to control the power, also apply in this case to the areas for such a pixel.

FIG. 2b is an illustration of an element 209 for an alternative panel according to an embodiment of the present invention, together with power and drive elements. As described above, an electroluminescent material doped for blue may be caused to exhibit, by controlling the frequency of the power, to exhibit a range of colors including shades of green and blue. By this fact an R G B pixel may be made with two doped areas rather than three. In FIG. 2b pixel 210 comprises two material areas, 220 and 221. Area 220 is doped and controlled to exhibit various shades of red, and may also be intensity controlled. Area 221 is controlled to exhibit shades of green, alternated with exhibiting shades of blue. All three colors, r, g and b may therefore be produced with the two doped areas.

In FIG. 2b a power supply 223 provides power to both areas 220 and 221, and a controller 224 controls the frequency by controlling the connection to ground for both areas independently. As described above for other embodiments the transistors may be in the power lines to the areas from the power supply, or control circuitry may be built into the power supply.

FIG. 2c is a diagrammatical control schematic illustrating one way to control the R G B pixel of FIG. 2b to combine red, green and blue to make integrated colors. In this example power supply 224 has three frequency outputs, labeled for simplicity F1, F2 and F3. F1 is the frequency for area 220. F2 and F3 provide frequency alternately for area 221. FIG. 2d is a time diagram for F1, F2 and F3 on lines 226 and 227. Over a period of time to t1 F1 remains constant, providing a constant color output for area 220. Over that same time period t1, line 227 is driven for one-half the period at F2 and for one half the period at F3. Switching is accomplished through controlling switching element 231 in the power supply. After period t1 F2 is again applied to line 227, and then F3 as shown in the same time pattern as for the period to t1. This alteration continues until a new color is required for the pixel, at which time a new set of R G B frequency values is provided for F1, F2 and F3. For a pixilated display it will apparent to the skilled artisan that conventional R G B display driver circuitry may be used with some alteration. The same is true for the three-area display of FIG. 2a.

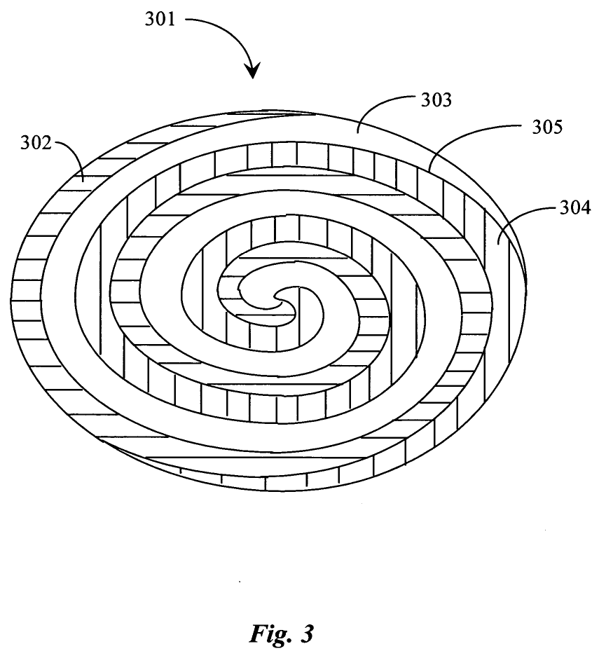

FIG. 3 is a plan view of a color swirl 301 that may be used in an embodiment of the invention to create an areal region of controlled color. In areal swirl 301 shown in FIG. 3, the three different swirled areas 302, 303 and 304 are areas of electroluminescent panel material appropriately doped to produce red, green and blue areas, as are the three distinct areas in the example of FIG. 2a. Further, the area are separated in production by insulating material, as described above, so the three separate areas are electrically isolated from one another.

In the embodiment with reference to FIG. 3 there is no attempt to make pixels. Rather, the areas of electroluminescent material are made relatively thin (as would be done for pixel size) and the swirl is continued to a rather large diameter (depending on the ultimate use of the panel). Each separate area is powered as described above for FIG. 2a, so the overall apparent color and intensity of color of the resulting panel may be controlled.

The implementation shown in FIG. 3 is particularly useful for round and oval panels, and may be used for panels of other shapes by placing the swirled panel behind a diffuser panel of another shape, so the apparent color produced may be diffused over a panel of another shape, such as rectangular for example. Further, the implementation shown may be shaped somewhat differently to produce a flattened effect more nearly rectangular rather than round or oval.

Panels may also be made with the swirl pattern of FIG. 3 and similar patterns, but with two distinct separate areas, as shown for the pixel arrangement with reference to FIG. 2b, which may then be controlled as described above to provide the three R G B colors, but with two areas.

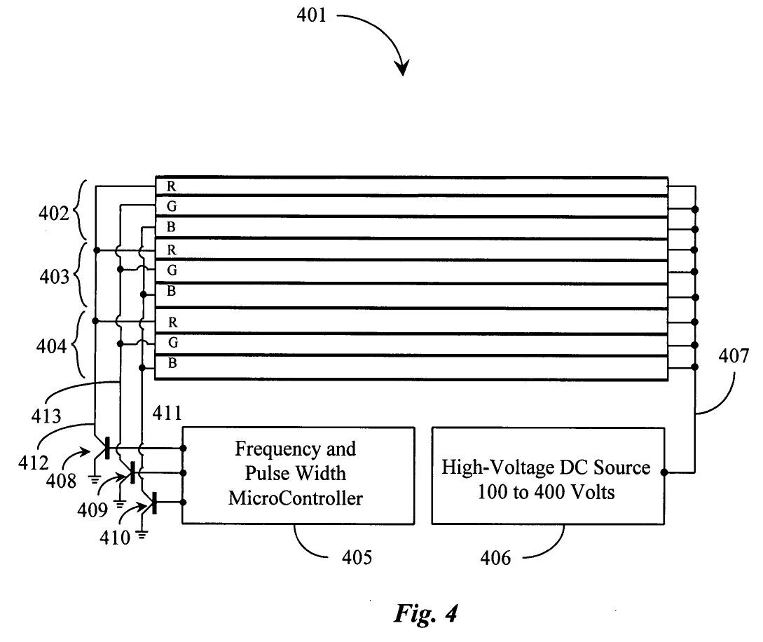

FIG. 4 is a representation of still another arrangement for producing color panels according to embodiments of the present invention. In the arrangement of FIG. 4 individual strips of electroluminescent material to produce nominal red, green and blue color output are fabricated in distinct groups such as groups 402, 403 and 404 of three strips each to make a panel. There will of course be many more than the three groups shown, but three are enough to describe the arrangement in an enabling way.

In this arrangement a high-voltage DC source 406 connects to all of the lines in all groups, so there is a common power supply. In some embodiments controls are provided to vary the voltage to control intensity of color produced by the panels, and in some embodiments there may be a capability of controlling a different voltage for individual ones of the strips.

A frequency and pulse-width microcontroller 405 controls separate transistors for each common color strip. That is, one transistor 408 is for all nominal red strips, transistor 409 is for all nominal green strips, and transistor 410 is for all nominal blue strips. By controlling the transistors, the time period and frequency that each strip is connected to ground is controlled, with all strips of one color controlled alike. In some cases, however, there may be separate groups of strips controlled differently.

The strips as shown in FIG. 4 are thin, on the order of the width of a pixel in an RGB pixel display, so the adjacent red, green and blue strips in each group will be perceived by the human eye to produce an integrated color, as occurs in a RGB pixel display. The strips are electrically insulated from one another, as was described above in other embodiments of the invention.

In the example of FIG. 4 the comments made above regarding the method of frequency control also apply, and the R G B requirement may also be accomplished with two side-by-side strips repeated instead of groups of three, by controlling one of the two red and the other green and blue alternately, just as previously described.

In this manner, then, a panel of any significant shape, rectangular in this example, but not necessarily so, may be produced and controlled to exhibit any one of a very broad range of colors and intensities, and different parts of a panel may be controlled to provide different colors and intensities.

It will be apparent to the skilled artisan that embodiments described are exemplary, and that there are a variety of ways alterations might be made in many embodiments without departing from the spirit and scope of the invention. In many embodiment of the invention separate areas are electrically insulated from one another, and separately powered so that one or both of voltage and frequency may be varied. As a result, appropriate controls, made available in many cases to an end user, may allow the user to alter the color and intensity to the users own preference. Generally speaking, voltage changes effect intensity, and frequency changes effect color. Intensity may change somewhat with frequency changes as well, so to maintain a consistent intensity as color changes, it is often important in embodiments of the invention to control both.

Because of the many applications and variations in powering and control that may be done within the spirit and scope of the invention, the invention is limited only by the scope of the claims that follow.

1. A variable-color display system, comprising:
at least one area of electroluminescent material;
a power supply connected to the area of electroluminescent material, providing electromotive force (emf) to the material; and
variable frequency control circuitry for controlling frequency of application of the emf applied to the area of electroluminescent material;
wherein by varying the frequency the apparent color of the display is changed.

2. The variable-color display system of claim 1 wherein the power supply is a variable voltage power supply, whereby the voltage may be varied to alter the intensity of the color exhibited.

3. The variable-color display system of claim 1 comprising two or more areas of electroluminescent material powered by the power supply, wherein the variable frequency control circuitry controls frequency for the two or more areas independently.

4. The variable-color display system of claim 3 wherein the power supply providing emf is a variable voltage power supply, allowing voltage level to be varied.

5. The variable-color display system of claim 3 comprising three areas of electroluminescent material, a first area comprising material formulated to provide a red color at a predetermined voltage and frequency, a second area comprising material formulated to provide a green color at a predetermined voltage and frequency, and a third area comprising material formulated to provide a blue color at a predetermined voltage and frequency, the three areas adjacent in close proximity and electrically isolated from one another.

6. The variable-color display system of claim 5 wherein each of the three areas are implemented as adjacent spots forming a pixel, and further comprising a plurality of such pixels in matrix, forming a pixilated R G B display panel.

7. The variable-color display system of claim 5 wherein each of the three areas is implemented as a long line, the areas side-by-side and electrically insulated, and further comprising a plurality of line sets forming a display.

8. The variable-color display system of claim 5 wherein each of the three areas is implemented as a long line, the areas side-by-side and electrically insulated, and the set of side-by-side long lines are formed in a spiral pattern.

9. The variable-color display system of claim 3 comprising two areas of electroluminescent material, a first area comprising material formulated to provide a range of red color under frequency control, and a second area comprising material formulated to provide a range of colors including various shades of both green and blue color under frequency control, the three areas adjacent in close proximity and electrically isolated from one another.

10. The variable-color display system of claim 9 wherein each of the areas are implemented as adjacent spots forming a pixel, and further comprising a plurality of such pixels in matrix, forming a pixilated R G B display panel.

11. The variable-color display system of claim 10 wherein frequency control is enabled to provide one frequency to the first area for a predetermined period of time, a second frequency to the second area for a first portion of the period of time, and a third frequency to the second area for a second portion of the period of time.

12. The variable-color display system of claim 9 wherein each of the areas is implemented as a long line, the areas side-by-side and electrically insulated, and further comprising a plurality of line sets forming a display.

13. The variable-color display system of claim 9 wherein each of the areas is implemented as a long line, the areas side-by-side and electrically insulated, and the set of side-by-side long lines is formed in a spiral pattern.

14. A method for providing a variable-color display system, comprising:
(a) forming at least one area of electroluminescent material;
(b) connecting a power supply to the area of electroluminescent material, providing electromotive force (emf) to the material; and
(c) providing variable frequency control to the application of the emf to the area of electroluminescent material, altering the apparent color of the panel according to the frequency.

15. The method of claim 14 wherein the power supply is a variable voltage power supply, whereby the voltage may be varied to alter the intensity of the color exhibited.

16. The method of claim 14 comprising two or more areas of electroluminescent material powered by the power supply, wherein the variable frequency control circuitry controls frequency for the two or more areas independently.

17. The method of claim 16 wherein the power supply providing emf is a variable voltage power supply, allowing voltage level to be varied.

18. The method of claim 16 comprising three areas of electroluminescent material, a first area comprising material formulated to provide a red color at a predetermined voltage and frequency, a second area comprising material formulated to provide a green color at a predetermined voltage and frequency, and a third area comprising material formulated to provide a blue color at a predetermined voltage and frequency, the three areas adjacent in close proximity and electrically isolated from one another.

19. The method of claim 18 wherein each of the three areas are implemented as adjacent spots forming a pixel, and further comprising a plurality of such pixels in matrix, forming a pixilated R G B display panel.

20. The method of claim 18 wherein each of the three areas is implemented as a long line, the areas side-by-side and electrically insulated, and further comprising a plurality of line sets forming a display.

21. The method of claim 18 wherein each of the three areas is implemented as a long line, the areas side-by-side and electrically insulated, and the set of side-by-side long lines are formed in a spiral pattern.

22. The method of claim 15 comprising two areas of electroluminescent material, a first area comprising material formulated to provide a range of red color under frequency control, and a second area comprising material formulated to provide a range of colors including various shades of both green and blue color under frequency control, the three areas adjacent in close proximity and electrically isolated from one another.

23. The method of claim 23 wherein each of the areas are implemented as adjacent spots forming a pixel, and further comprising a plurality of such pixels in matrix, forming a pixilated R G B display panel.

24. The method of claim 24 wherein frequency control is enabled to provide one frequency to the first area for a predetermined period of time, a second frequency to the second area for a first portion of the period of time, and a third frequency to the second area for a second portion of the period of time.

25. The method of claim 23 wherein each of the areas is implemented as a long line, the areas side-by-side and electrically insulated, and further comprising a plurality of line sets forming a display.

26. The method of claim 23 wherein each of the areas is implemented as a long line, the areas side-by-side and electrically insulated, and the set of side-by-side long lines is formed in a spiral pattern.
